(19) United States
(12) Patent Application Publication
(10) Pub. No.: US 2002/0100714 A1
(43) Pub. Date: Aug. 1, 2002

(54) Microfluidic devices

(76) Inventor: Sau Lan Tang Staats, Hockessin, DE (US)

Correspondence Address: Ratner & Prestia, P.O. Box 7228, Wilmington, DE, 19803, US

(21) Appl. No.: 10/061,001

(22) Filed: Jan. 30, 2002

Related U.S. Application Data
(60) Provisional application No. 60/265,431, filed on Jan. 31, 2001.
(60) Provisional application No. 60/310,337, filed on Aug. 6, 2001.
(60) Provisional application No. 60/341,069, filed on Dec. 19, 2001.

(51) Int. Cl. G01N 27/27

(52) U.S. Cl. 210/85; 210/174; 422/100; 422/104; 204/600

(57) ABSTRACT

Microfluidic devices that form layered structures provide a liquid handling interface with external devices as well as reduce consumption of sample and buffer in analytical operations. These microfluidic devices are suitable for operations designed for lab-on-a-chip functions. The microfluidic devices accomplish sample injection in a single channel without intersecting channels on the same plane. These devices may be formed through injection-molding fabrication methods.

This application claims priority to U.S. provisional application serial No. 60/265,431 filed Jan. 31, 2001; U.S. provisional application serial No. 60/310,337 filed Aug. 6, 2001; U.S. provisional application serial No. 60/341,069 filed Dec. 19, 2001; and U.S. provisional application serial No. unknown filed Nov. 28, 2001.

### FIELD OF THE INVENTION

This invention relates to microfluidic devices. These devices form layered and three-dimensional structures and provide a liquid handling interface with external devices. These microfluidic devices are suitable for operations designed for lab-on-a-chip functions.

### BACKGROUND OF THE INVENTION

A microfluidic, or lab-on-a-chip (LOC), device is a planar device, one surface of which contains some of the following microfluidic features: intersecting channels, reservoirs, valves, flow switches, etc., which are fabricated using semiconductor microfabrication technology. The device surface is typically bonded to another planar surface so that the channels are enclosed except at samples and buffer input and output points. Microfluidic devices are designed for complex laboratory functions such as DNA sequencing, analytical separation and measurements. The first of such devices disclosed in the patent literature was made of silicon as disclosed by Pace in U. S. Pat. No. 4,908,112. in biotech and pharmaceutical industries. Applications of planar microfabricated devices primarily include using electroosmotic, electrokinetic, and/or pressure-driven motions of liquids and particles for fluid transport. The proceedings of the Micro Total Analysis Systems-2000 Symposium (A. Van Den Berg and W. Olthuis, ed., Kluwer Academic Publishers, Dortrecht (2000)) highlight the recent rapid progress in the field of microfluidics.

A common means of injecting samples into the enclosed fluid channels for analytical operations such as capillary electrophoresis (CE) is intersecting channels connecting the sample reservoirs to the main fluid separation channels. The intersecting channels can be in the form of a ‘T’, as first disclosed in U.S. Pat. No. 4,908,112, or a cross, as shown in FIG. 1. Referring to FIG. 1, a sample to be injected from the sample reservoir 1 to the fluidic channel by an electrokinetically driven operation requires a voltage (Vs) to be applied to the sample reservoir or well. Another voltage or electrical ground (Vsw) is applied to the sample waste reservoir 2, typically situated beyond the junction point of the sample injection channel and the main fluidic channel. A stream of the sample is electrokinetically transported from the sample reservoir toward the waste reservoir, intersecting the main fluidic channel en route. An injection plug into the main fluidic channel is formed when the voltage difference Vs-Vsw is reduced or eliminated, thus stopping the stream, and another voltage, Vb, is applied to the run buffer well 3 and, a voltage Vbw the buffer waste well 4. In this mode of sample injection, a sample well, a buffer well and at least 1 waste well are needed. Even when only several nanoliter of sample is needed for the separation experiment, a much larger quantity of sample must be placed in the sample well to establish the flow toward the main microfluidic channel, which may be the CE separation channel.

If automatic sample filling of the device is needed as in the case of 96-channel CE devices for high-throughput applications, a coupler such as that described in E. Meng et al., Proceedings for Micro-TAS 2000, ibid. pp. 41-44., can be used to couple the sample from an external vessel into the sample well on the device via a capillary. Once the sample is deposited into the sample well, the same injection procedure as described above is carried out.

In liquid phase applications, especially in capillary electrophoresis, the channel widths used by those skilled in the art are generally uniform in width with the most common width at about 100 μm or smaller.

The prevailing method for manufacturing commercially available microfluidic devices comprises generally of the following sequence of steps:

1) Spincoating a layer of photoresist on a substrate, typically a piece of flat Pyrex® glass with or without a layer of chrome.

2) Fabricating a photomask with the desired microfluidic design with methods known in the art.

3) Imprinting the desired microfluidic design on the photoresist by exposing the photoresist coating to light through the photomask with the design on it.

4) Develop the photoresist coating so that the locations for microfluidic features on the glass will be bare, and the rest of the glass will be under the coating.

5)Direct etching of the exposed areas with acids such as hydrofluoric acid (HF) so that channels, reservoirs, etc., will be formed by the acid removal of the glass.

### SUMMARY OF THE INVENTION

To achieve these and other objects, and in view of its purposes, the present invention provides microfluidic devices comprising:

A) a substrate with a top surface comprising a channel. The channel has a width, a bottom and a sidewall;

B) a cover positioned over the substrate in alignment with the substrate; and

C) an access port to the channel, wherein the access port and the channel sidewall are non-intersecting.

The invention further includes an embodiment in which the access port to the channel is an opening on the channel bottom, along with an embodiment in which the access port to the channel is an opening on the cover.

Another embodiment of the invention includes a microfluidic device further comprising a capillary positioned in the channel access port and inserted in the channel. The access port has a diameter and the capillary has an outer diameter, and the outer diameter of the capillary and the access port diameter are approximately equal.

Another embodiment of the invention further comprises a capillary positioned in the channel access port and inserted in the channel. The cross-sectional area of the inside of the capillary and the cross-sectional area of the channel are approximately equal.

Yet another embodiment of the present invention is a process of making a microfluidic device, the device comprising a substrate and a channel architecture. This method comprises preparing an injection-molding mold. Preparing the injection-molding mold comprises forming a negative impression of the channel architecture, injecting a polymeric material into the injection-molding mold, and curing the polymeric material.

The injection molding mold might be prepared from a material selected from the group consisting of metal, silicon, ceramic, glass, quartz, sapphire and polymeric material.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a schematic drawing showing the ‘T’ or ‘cross’ configurations for sample injection commonly used in LOC devices in prior art.

FIG. 2 shows top and section schematic views of a microfluidic lab-on-a-chip device according to one embodiment of the present invention.

FIG. 3 shows top and section schematic views of a microfluidic lab-on-a-chip device allowing sample injection and separation to be carried out in a single channel according to one embodiment of the present invention.

FIG. 4 shows a schematic of a microfluidic lab-on-a-chip device with a capillary connected to the microfluidic channel according to one embodiment of the present invention.

FIG. 5 shows a schematic of a microfluidic lab-on-a-chip device with a hole in the microfluidic channel connected to another microfluidic channel in another substrate according to one embodiment of the present invention.

FIG. 6 shows a schematic of a microfluidic device according to one embodiment of the present invention.

FIG. 7 shows a schematic of a microfluidic device with a cover containing interconnecting ducts according to one embodiment of the present invention.

FIG. 8A shows a schematic sectional view of a microfluidic device according to one embodiment of the present invention.

FIG. 8B shows a schematic sectional view of a microfluidic device with partially raised walls according to one embodiment of the present invention.

FIG. 8C shows a schematic sectional view of a microfluidic device with raised walls according to one embodiment of the present invention.

FIG. 9A shows a schematic sectional view of a microfluidic device with an alignment structure according to one embodiment of the present invention.

FIG. 9B shows a schematic sectional view of a microfluidic device with an alignment structure according to another embodiment of the present invention.

FIG. 10A shows a schematic sectional view of a microfluidic device according to one embodiment of the present invention.

FIG. 10B shows a schematic top view of a substrate containing a microfluidic channel with raised walls according to one embodiment of the present invention.

FIG. 11A: shows a schematic top view of a substrate containing a microfluidic channel with a diaphragm built into each side of the raised channel walls according to one embodiment of the present invention.

FIG. 11B shows a schematic of the device in FIG. 11A when high voltage is applied to close the diaphragm valve.

FIG. 12A shows a schematic top view of an open channel with raised channel walls according to one embodiment of the present invention.

FIG. 12B shows a schematic top view of an open channel with raised channel walls with additional structures according to one embodiment of the present invention.

FIG. 13 shows schematic top and sectional views of an assembled microfluidic device according to an embodiment of the present invention.

FIG. 14 shows a schematic top view of a set of open nested channels according to one embodiment of the present invention.

FIG. 15 shows a schematic top view of a microfluidic device with a channel that is used to increase optical path and optical fiber cables according to one embodiment of the present invention.

FIG. 16 shows a schematic of a device with an electrospray nozzle configuration.

FIG. 17 shows a schematic of the device with a channel suitable for a two-dimensional separation with a large number of input and output ports.

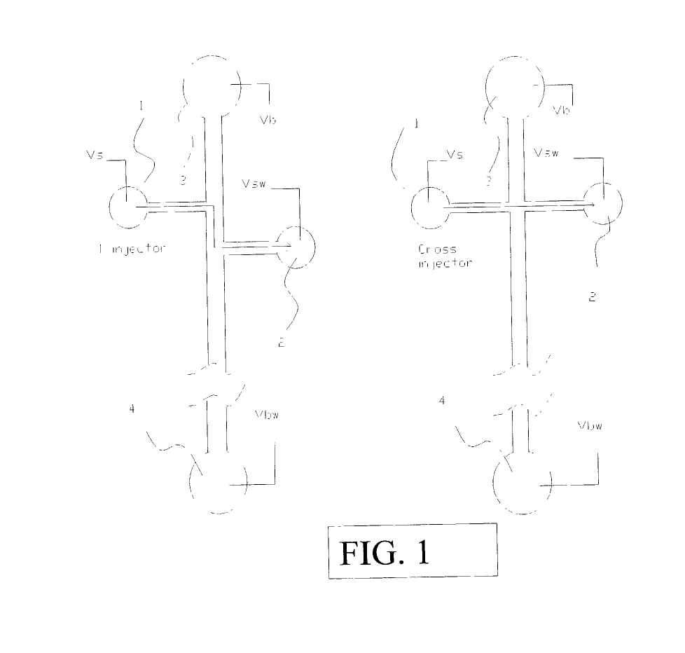

### DETAILED DESCRIPTION OF THE INVENTION

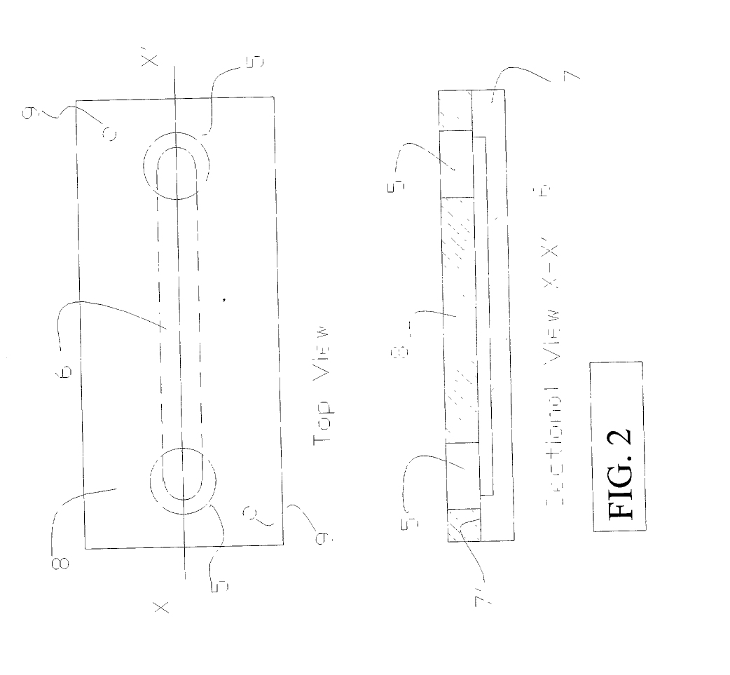

The microfluidic devices of the present invention allow for sample injection and separation to be carried out in a single channel. Referring now to the drawings, wherein like reference numerals refer to like elements throughout, FIG. 2 shows top and section views of a schematic representation of a microfluidic device according to one embodiment of the present invention with a substrate 7 and a single channel 6 therein. The substrate has a top surface 7′ and a cover piece 8 is shown positioned above the substrate 7.

The channel 6 has a bottom and a sidewall, and a defined width. According to the present invention the microfluidic channel 6 has a width larger than 100 μm, preferably larger than 250 μm. The depth of the channel is defined by the height of the sidewall and is preferably between 10 and 50 μm. The larger critical dimensions of the channel structures of the present invention are conducive to the relative ease of fabricating microfluidic features such as microfluidic channels and access ports in a single step in polymeric substrate materials. The device shown in FIG. 2 comprises a channel wherein the bottom of the channel is coplanar with a plane beneath the top surface of the substrate. The channel shown in FIG. 2 is herein referred to as a buried channel. As described in more detail below, the channel bottom may be coplanar with the top surface of the substrate, and this channel architecture is herein referred to as a raised channel.

As shown in FIG. 2, the cover 8 has access ports 5 that align with channel 6. The access ports 5 are aligned with the microfluidic channel by means of locating devices 9 shown in this diagram as dowel pins, but may be other kinds of location devices capable of aligning two separate pieces to an accuracy of 0.001 inch (25 μm) or better.

To aid the alignment of the access port in the cover to the channel, or in the alignment of one channel to a channel in another substrate, locating devices such as dowel pins, locating edges, protrusions from the substrate or cover or other locating devices that accurately align separate pieces may be incorporated into the substrates. The relatively large width of the channel in this design allows alignment to within 25 μm or 0.001 inch. Such accuracy is feasible with current alignment devices.

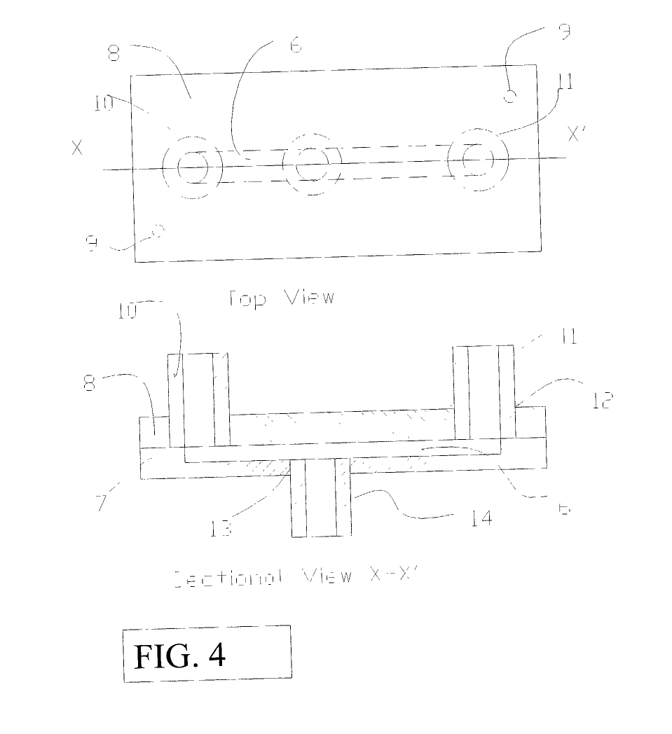

The access ports, or holes may be in the cover that is bonded to the surface of the substrate containing the microfluidic channel to seal the channel, as shown in FIG. 2, or alternatively the hole may also be at the bottom of the channel such that the opening of the hole goes through at least part of the thickness of the substrate, as shown in FIG. 4. At places along the channel where sample injection is desired, an access port will be positioned. The access ports are preferably round and have an internal cross-sectional area approximately the same as the cross-sectional area of the channel. The access port and the channel may be aligned to minimize the disruptive flow of the fluid because of the mismatch of the internal volumes when the fluid flows from the capillary to the microfluidic channel.

The access ports, whether formed in the cover or below the channel, or in another substrate aligned with the channel substrate, provide access to the channel from either above or below the plane of the channel. This architecture obviates the need for intersecting channels on the same plane for sample injection purposes. Because the channel architecture eliminates the need for samples to be stored for loading purposes on the device, sample and buffer amounts are limited to only the amount consumed by the device operation. This aspect of the invention is critical in situations when very minute amounts of the sample are available. With the channel architecture of the present invention, a substrate with a top surface comprising a plurality of non-intersecting channels can be used to perform microfluidic functions by providing interconnections between channels and other devices through connections existing outside the plane of the substrate surface.

The cover and substrate of the microfabricated microfluidic devices of this invention may be formed of the same types of materials, such as glass, quartz, various polymers, insulated materials such as ceramics, and semi-conducting materials such as silicon. Alternatively, the cover may be made of one material and the substrate may be made of a different material. In particular, the cover may be made of quartz and the substrate with the microfabricated features may be made of an elastomer such as polydimethylsiloxane (PDMS). Stacked structures comprising multiple layers of substrates may be made of the same material or different materials. The microfluidic features within such a stacked device may be aligned accurately from layer to layer using mechanical alignment means as described herein.

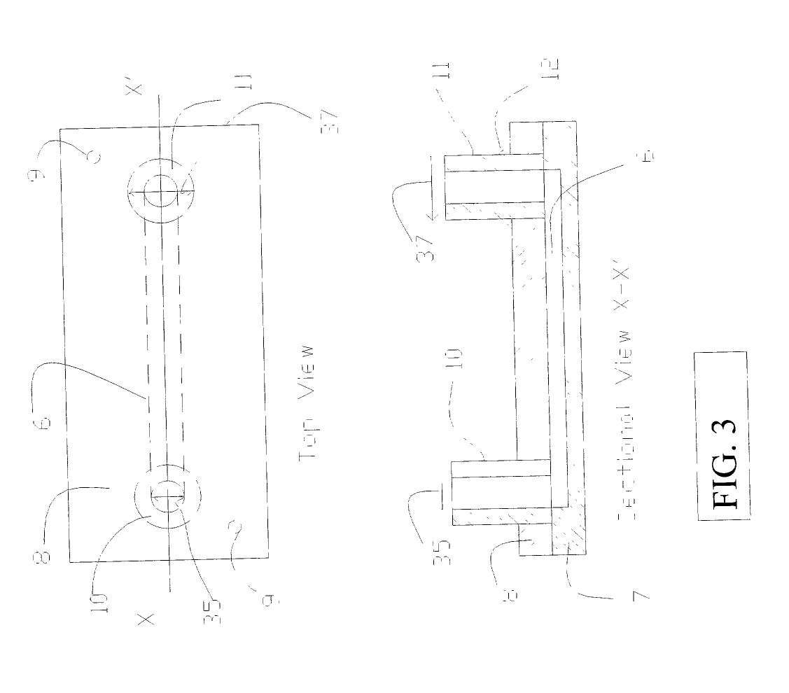

FIG. 3 shows a microfluidic device that provides sample injection and separation to be carried out in a single channel. Capillaries 10 and 11 are positioned in the access ports, which are aligned with the channel 6. The capillaries are sealed to the access port openings with sealant 12. Sample injection into the single channel is through one of the capillaries 10 or 11 inserted in the holes 5 in the cover piece. Adhesive sealant (12) may be used on junction of the capillaries and the access ports to prevent fluid leakage from the microfluidic channel to the outside.

Shown in FIG. 4, is a device with an access port 13 in the channel bottom. This access port is positioned inside the microfluidic channel itself, whereas the access ports shown in FIGS. 2 and 3 were positioned in the device cover to allow access to the channel. The capillary 14 is inserted in the access port 13 to provide sample injection or a connection to other devices or elements within the same device.

As shown in FIG. 3, the capillaries have an inner diameter (I.D.) 35 and an outside diameter (O. D.) 37. The O.D., the diameter of the access port and the diameter of the capillary are approximately equal. This provides a tight fit between the access port opening and the capillary. An adhesive may be placed around the O. D. of the capillary at the junction with the access port to improve the seal of the connection and prevent fluid leakage.

The capillary may be a standard capillary commonly used in capillary electrophoresis or micro HPLC, i.e. silica tubing with an outer coating of polymer. Other types of capillaries, preferably made of polymers, may also be used. The capillary may be made of the same polymer as the substrate or a different material, The capillary may also be optically transparent. Preferably, the end of the capillary inside the access port does not protrude beyond the thickness of the substrate in which the access port reside.

At least two access ports with capillaries inserted as described above are typically needed for each channel, as shown in FIG. 4. In one embodiment of the present invention, one access port provides a capillary to inject a sample. The open end of this capillary is immersed in a sample reservoir that may or may not be an integral part of the microfluidic device. Additionally, the open end of another capillary is likewise immersed in another external reservoir. Either electrokinetic flow or pressure flow is induced to drive the fluid from the sample reservoir into the microfluidic channel. Likewise fluid can be driven from a channel on one substrate into another channel on the surface of another substrate if the channels are connected through the access ports extending through the thickness of the first substrate.

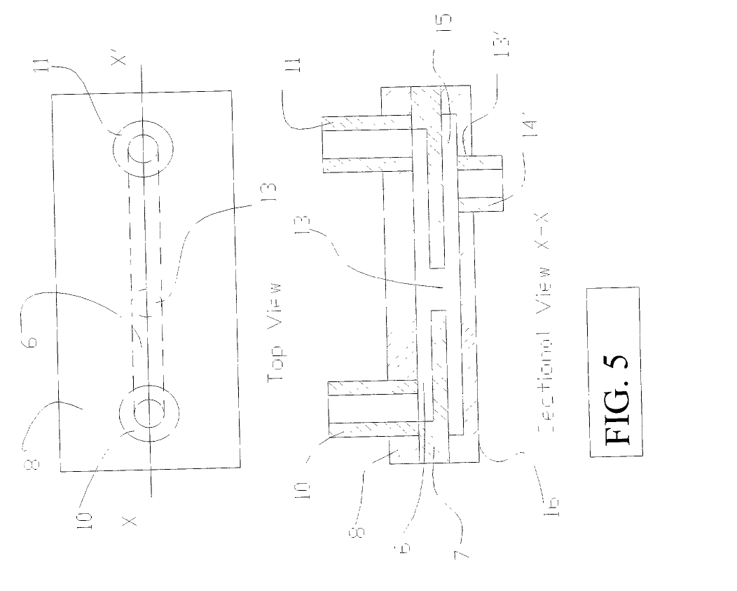

Referring to FIG. 5, a similar microfluidic device as in FIG. 4 is illustrated. The access port 13 in the microfluidic channel 6 shown in FIG. 5 is connected to another microfluidic feature, in this case, another microfluidic channel 15 in a second substrate 16. The secondary channel 15 may or may not be connected to other devices through an access port 13′ and a capillary 14′. Additional layers of substrates comprising various microfluidic features may be combined in this method. By stacking the microfluidic devices, sophisticated microfluidic architectures can be accommodated in devices that require minimal size in area, but provide adequate device operating space though multiple layers of substrates.

In another embodiment of the invention, individual microfluidic channels in the same device or in separate devices may be connected with capillaries. This is analogous to ‘jumpering’ in electronic circuits. Using capillaries to provide connections on microfluidic devices greatly enhances the applications of these devices as various operations can be interconnected.

For example, a polymer device for separation may be connected to a silicon-based device with a heater or other built-in functions for use in the same chemical or biochemical process. The jumper-connection concept facilitates experimentation with various device configurations before committing to a final device architecture for a series of processes. This embodiment of the present invention provides a microfluidic device equivalent to breadboarding in conventional electronic circuits. To extend the utility of these devices, common reservoirs containing a variety of liquids such as samples and buffers may be fed to different channels through capillaries. The capillaries may easily be connected or disconnected during the optimization of the device design.

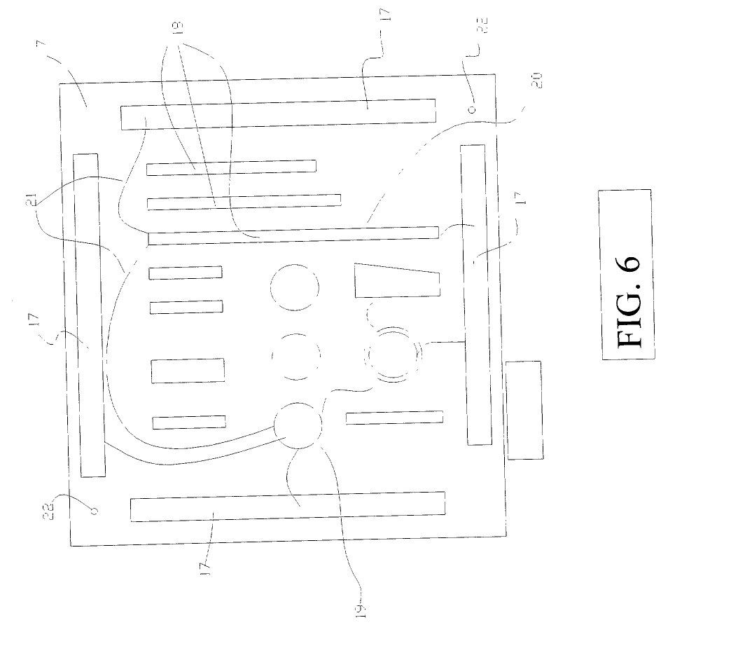

Referring to FIG. 6, a possible configuration of various microfluidic devices is shown with common reservoirs 17 for samples, buffers, mobile phases, waste, etc. A variety of microfluidic features such as channels 18 of different widths, depths and lengths, a microreactor 19 and a detector window 20 are indicated. Other possible microfluidic features may also be incorporated into the device through capillary connections 21. The positions of these various microfluidic features are flexible. Capillaries 21 connect one element to another in accordance with the particular application. The devices may also have covers with access ports that accommodate the capillaries. As previously described, the cover and the substrate align with alignment devices 22.

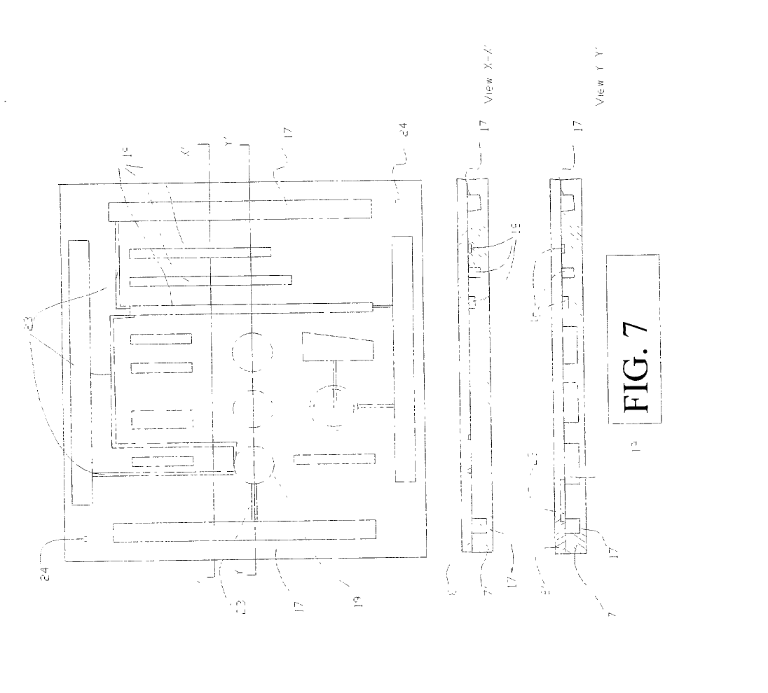

The cover may also contain interconnecting ducts 23, as shown in FIG. 7. The interconnecting ducts 23 formed in the cover 8′ of FIG. 7 replace the interconnecting capillaries 21 shown in FIG. 6. These interconnecting ducts are formed on the surface of the cover 8′ that interfaces the substrate 7′ such that fluid may flow between the cover piece 8′ and the top surface of the substrate. All the microfluidic features shown in FIG. 7 are interfacial structures between the cover and the substrate. As previously described, the cover 8′ and the substrate 7′ are aligned by alignment devices 24. While not shown explicitly, the cover may also contain analytical channels in accordance with the invention.

In addition to the top view of a microfluidic device, two section views of the same microfluidic device are also illustrated in FIG. 7. The view across the X-X′ section reveals the substrate reservoir 17 and channel 18 features, as well as the interconnecting ducts 23 of the cover piece 8′. The view across the Y-Y′ section also reveals the substrate reservoir 17 and channel 18 features, in addition to a microreactor 19 in the substrate. The interconnecting duct 23′ of the cover is apparent in the Y-Y′ view connecting the microreactor 19 to one of the reservoirs.

In additional embodiments, the microfluidic devices of this invention are suitable for chromatographic and electrophoretic separations in which the detection of the components in the fluid is performed by ultraviolet, visible, fluorescence, chemiluminescence, and scattering spectroscopy, as well as by means of electrochemical and electroconductivity detection. In utilizing ultraviolet (UV) spectroscopy for detection, a wide separation channel (e.g. >250 μm) allows at least 2.5 times more sample than conventional channels (typically around 100 μm wide) to be injected into the separation channel. An increased amount of sample increases the amount of analytes to be detected by techniques such as mass spectrometry and UV spectrophotometry.

Another embodiment of the invention provides UV light transversely to the channel such that the optical path length of the UV light at least 2.5 times that of the traditional 100 μm wide, 25 μm deep microfluidic channel.

In still another embodiment of the invention, the free end of a capillary is inserted into an access port and used as a nozzle for electrospray ionization for mass spectrometry detection. The free end of such a capillary may also be tapered to increase the effectiveness of electrospray ionization.

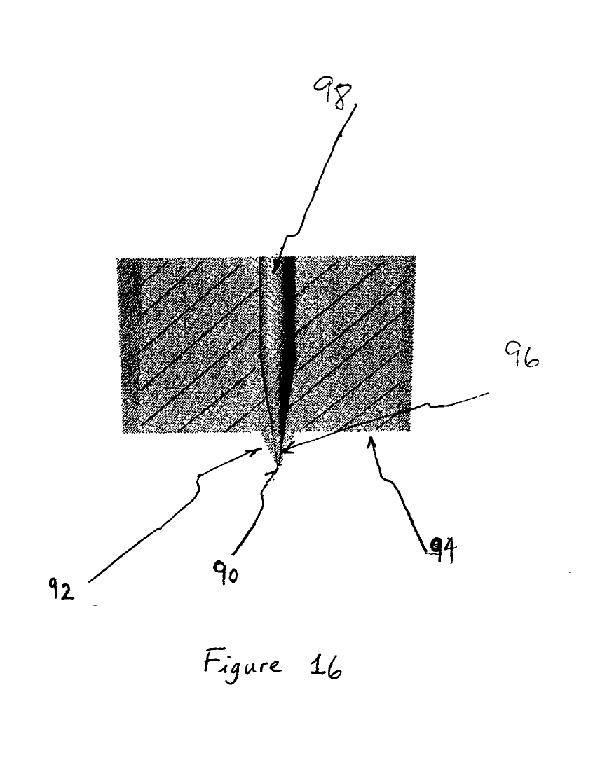

Similarly, the device channels may also be tapered to provide a conical nozzle adapted for electrospray or MALDI spotting applications. An example of such a channel is shown in FIG. 16. A cross section view through a nozzle-microfluidic channel structure is shown with an open nozzle end 90 about 20 μm in diameter, surrounded by a conical structure 92 protruding from the surface of the substrate 94. A cylindrical or conical microfluidic channel 96 through the thickness of the substrate connects the reservoir 98 to the nozzle 90. The nozzle and the microfluidic channel are formed in a single substrate. As shown here, the channel forms a nozzle that can be used with other devices as an electrospray nozzle, such that a single microfluidic device can be used for assays, and sample analysis preparation. The microfluidic device with electrospray nozzle features can be used in conjunction with detection devices such as mass spectrometers for sample analysis. Multiple nozzles and microfluidic channels may be arranged in an array format compatible with those of microtiter plates.

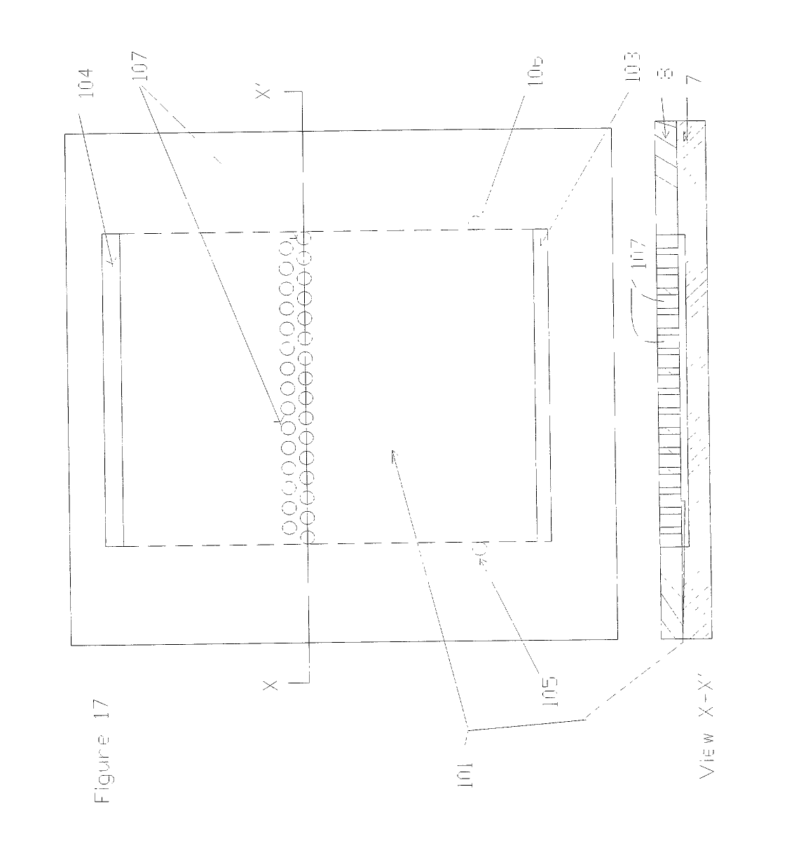

In still another embodiment of the invention, the microfluidic channel may have multiple inlet and outlet ports in the same channel, which is made wide enough to accommodate the number of ports. The channel in this embodiment preferably has an aspect ratio of width to depth of at least 100, with the depth being from about 10 μm to about 50 μm. The upper limit of the width to depth aspect ratio may be as high as about 50000, and separations of different nature may be carried out along the width and length of the channel. The fluidic channel is enclosed except where there are openings or ports for input and waste of sample, buffer, gel and other components needed for the methods of operation of the fluidic device. As illustrated in FIG. 17, the input port 103 and waste port 104 for the buffer and gel are placed at the opposite ends of the length of the fluidic channel 101; the sample input port 105 and the sample waste port 106 are placed on opposite ends of the width of the fluidic channel, and a series of openings or ports 107 for sample selection and output is placed along the width of the fluidic channel between the gel and buffer input opening and the gel and buffer waste opening.

The large width to depth ratio of the fluidic channel shown in FIG. 17 may require support structures within the volume to prevent the top and bottom of the fluidic volume to collapse upon each other. The support structures may be columnar structures, which are integral parts of the inner surface of the top or the bottom of the fluidic channel. These columnar features may also be arranged along the length of the fluidic channel at regular intervals from side to side to form channel-like features to minimize sideway motion of the fluid inside the wide fluidic channel.

The series of the sample select ports 107 may be arranged in some specific configurations such as in two or more rows. The openings in the first row stagger those in the second row spatially as closely as possible. In this manner the openings access the entire width of the fluidic channel reducing the space along the width of the fluidic volume that is inaccessible by the openings. The sample input and output ports may be connected to capillaries or other layers of microfluidic features as described herein.

The embodiment of the invention in FIG. 17 may be applied to proteins separation. Along the length and width of the fluidic channel are disposed a plurality of metallic films or wires that are in contact with the fluids and particles within the fluidic volume and are also connectable to external electrical power supplies. In one embodiment, a metallic film or wire running the width of the fluidic volume is positioned around the midpoint of the length of the fluidic volume. Metal films or wires are also disposed in the openings for sample input and output. All the metallic components can be connected to external power supplies for supplying voltages for the two-dimensional electrophoresis separations. If one side of the microfluidic channel is used for isoelectric focusing separation, amphoteric materials are disposed along that side of the microfluidic channel to create a pH gradient appropriate for the isoelectric focusing separation.

In another embodiment of the invention, the combination of multiple layers of substrates and covers progresses to improve alignment and possibly form additional features through specific features provided on the substrates and cover pieces.

The raised microfluidic features of a substrate according to the invention are amenable to secure bonding to a second substrate. The tight tolerance fitting of the protrusions and channel features provides mechanical fastening between the two substrates. Further securing of two substrates may be achieved through applying an appropriate adhesive to the outside of the raised walls of the channels such that the adhesive remains on the exterior of the microfluidic channel. The application of the adhesive may be with an inkjet scanner that “writes” a thin layer of adhesive on the outside walls of the microfluidic features.

Bonding substrates together may include heating the aligned substrates to appropriate temperature such as a of heat deflection temperature of one of the polymers, and applying pressure with a spacer of appropriate height between the two substrates. A thin film of an appropriate solvent for the polymer may also be applied to the outer surface of the raised wall for bonding purposes. For example, methylene chloride may be used for many polymers and hexane may be used for polyalkanes.

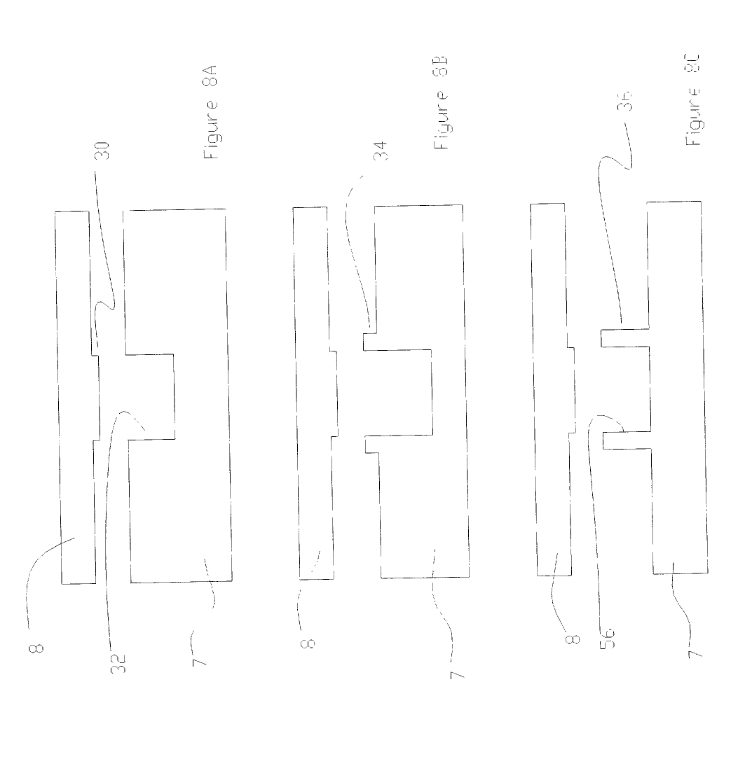

A sectional view of various microfluidic devices are shown in FIGS. 8A, 8B and 8C that illustrate some of the features provided the function to form a substrate-to-cover interface. In FIG. 8A, a channel in the substrate 7 has a sidewall 32. The cover piece 8 has a protrusion 30 that extends from the cover piece to fit into the channel. The orientation of the channel and the protrusion are designed so that the interface between the channel and the protrusion serve to align and secure the substrate and cover piece connection. The shape of the channel may vary in accordance with the invention and is not necessarily rectangular as shown. Preferably, the protrusion 30 fits into the channel in the substrate 7 with a tolerance of better than 25 μm, and the microfluidic channels may be about 20 μm to several hundred μm wide or in diameter.

A cover and substrate can interface to form additional microfluidic features at the interface when raised or partially raised channel walls are used in forming the devices. In FIG. 8B, a microfluidic channel is shown with partially raised walls 34. Similarly, a microfluidic channel 56 with raised walls 36 is shown in FIG. 8C. The raised channel walls are an integral part of the substrate 7, and are formed of a similar material as the substrate.

In the raised channel embodiment of the invention, the channel bottom may be coplanar with the top surface of the substrate, and the channel sidewalls rise from the substrate surface at an angle between about 45 and 135 degrees. The substrate and the sidewalls are preferably composed of a polymeric material. The polymeric material may be a low melt viscosity polymer.

Additionally, the protrusions may facilitate an interface between multiple substrates containing microfluidic features. The interface may include a recess region to receive protrusions from another substrate so that the channel in one substrate and the microfluidic features such as inlet and outlet access ports for the channel in a second substrate are aligned to an accuracy better than 25 micron.

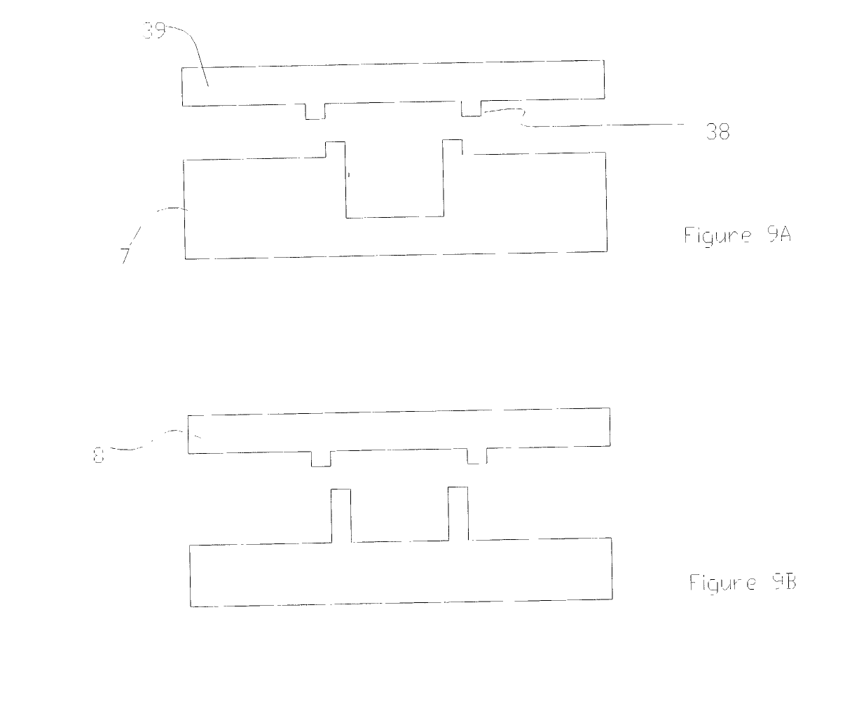

Similarly to a substrate to cover interface, a substrate to substrate interface may include alignment features incorporated into the channel designs. Such features include ridges rising above the walls of the microfluidic channel, as shown in FIG. 9A as an alignment protrusion 38. These types of alignment protrusions preferably extend up to 100 μm above the top surface plane of the substrate. The corresponding protrusion on the bottom surface of the second substrate 39, the dimensions of the said protrusion is such that it fits tightly into the channel opening of the first substrate 7. The channel depth with the second substrate 39 in place may be between 10 and 100 μm, and preferably between 10 to 50 μm. This alignment provides features such as access ports in a second substrate to align with features in the first substrate.

In a microfluidic device comprising more than one channel and other microfluidic features such as reservoirs on the surface of a first substrate, at least one of these microfluidic features may have mating features in the surface of a second substrate to achieve alignment for all the microfluidic features.

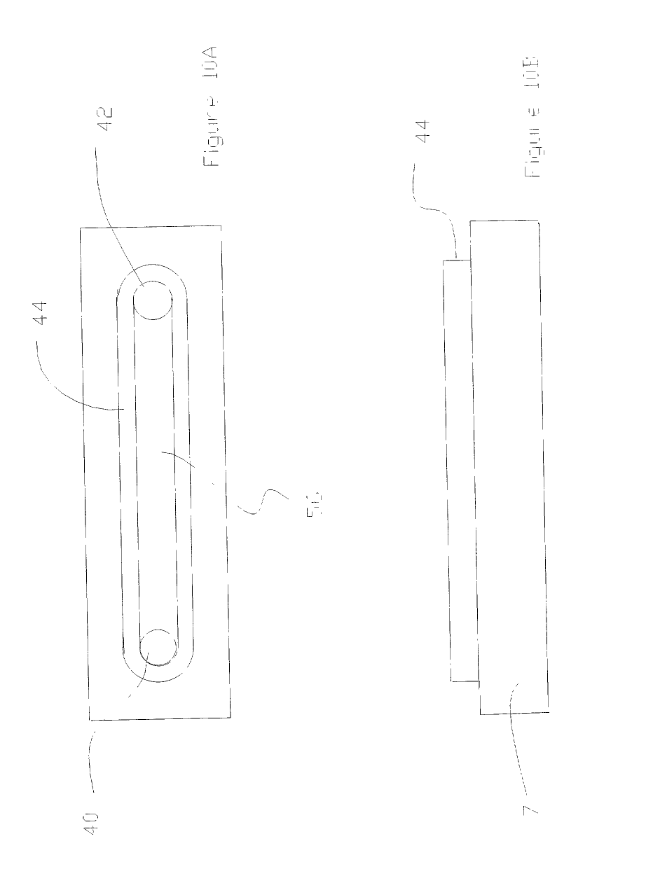

Channels with alignment features may also be formed above the top surface of the substrate, i.e., the channel floor is coplanar or above the top surface of the substrate. The alignment features for these raised channels may be the same as those described above, as shown schematically in FIG. 9C and FIG. 10B.

One embodiment of the invention includes channels with variable depths. This may be employed, for example, to increase the optical detection signal by increasing the optical path length through a channel. A channel may increase in depth to increase the optical path length of the optical beam. The floor of the channel may be lowered to achieve greater depth for a specified portion of the channel. To achieve this effect, the heights of the raised walls of the various microfluidic elements may be adjusted so that when a second substrate is aligned with the first substrate, the microfluidic channels and other features are properly enclosed.

Microfluidic devices with a variety of protrusions and raised wall features are illustrated in FIGS. 10-13. FIG. 10 A provides a top view of a substrate 7 containing a microfluidic channel 56 with raised walls 44. The device includes one fluid inlet port 40 and one fluid outlet port 42. A side view of this device is shown in FIG. 10B to illustrate the elevation of the raised channel walls 44.

In general, the thickness of a raised channel wall may be about 25 μm, and preferably larger than 100 μm, or may be of more than one thickness.

Along the length of the raised wall, a small portion of the wall, about 1 mm or longer, may be made thinner than the rest of the wall thickness, e.g. less than 25 micron. On the opposite side of the thinned region of the raised wall channel, a corresponding portion of the channel wall may likewise be thinned out. The thin regions of the wall may provide diaphragms for a flow-control valve. Dimensions of the thinned regions on the wall are determined according to the elastic properties of the polymer forming the device. The thinned region of the wall allows enough flexing so that non-elastomers may be used as diaphragms. To actuate the thinned walls, a metal film may be deposited on the outside surface of the each thinned wall. When a high voltage difference is applied across the metal films through the width of the channel, electrostatic attraction of the two electrodes through the dielectric (the polymeric walls) will flex the thinned polymeric wall so that the channel size can be restricted to control flow. By varying an applied voltage, the thin wall diaphragm may be used to create pumping action for the fluid inside the channel. A set of thin-wall diaphragm valves with their respective electrodes for supplying voltages appropriately located in a set of intersecting channels may be used to direct the flow of the fluid from one channel to another.

The actuation of the thinned wall as diaphragm may be achieved through pressure means. Pneumatic pressure may be applied by a high gas pressure outside of the raised channel wall. The higher pressure outside the channel may flex the thinned walls toward each other. For pneumatic activation, only one thinned wall may be needed if one thinned wall can flex enough to close the channel. Another pressure means may be mechanical pressure exerted by a plunger or piston-like structures, or any structures that serve the purpose of exerting pressure on the thinned part of the wall or walls. The mechanical pressure generator does not need to be an integral part of the microfluidic devices.

The thinned walls of the channel may also be located in the first substrate such that the one portion of channel bottom, and the corresponding portion of the cover of the channel are thinned to form the diaphragms.

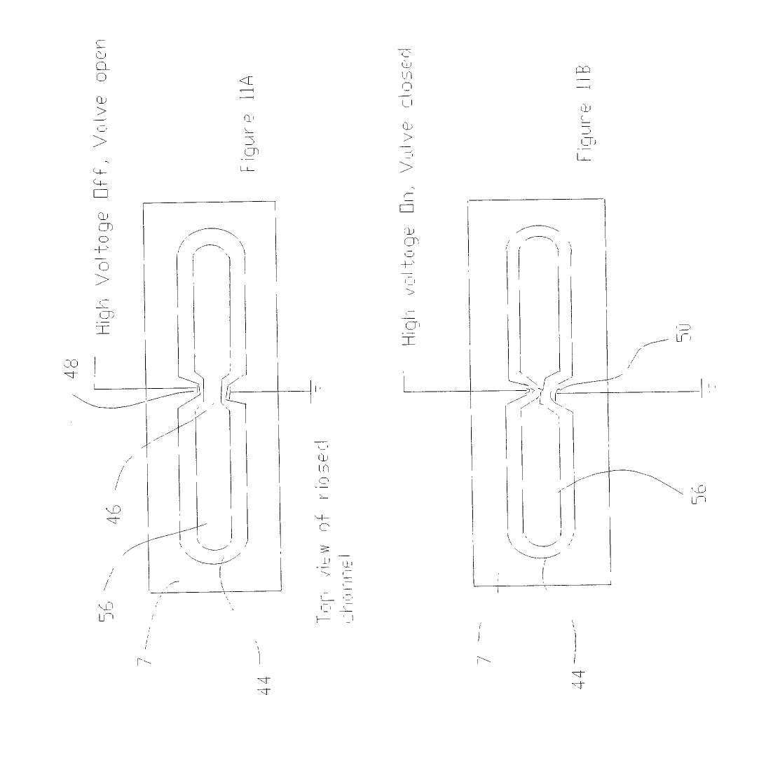

FIG. 11A shows a top view of a microfluidic channel without a cover that has a diaphragm 46 formed into opposite sides of the raised channel walls. Electrodes 48 are attached to the thin regions of the channel walls that define the diaphragms. The configuration shown in 11A represents an open diaphragm, and a closed diaphragm 50 is represented in FIG. 11B. In one embodiment, the opening and closing of the diaphragm is controlled by voltage applied to the electrodes 48. For example, with the voltage turned off, the diaphragm remains open, as in FIG. 11A. When the voltage is turned on, the diaphragms are pushed in by electrostatic forces and close the valve, as shown in FIG. 11B.

In another embodiment of the invention, both the outside and inside surfaces of the raised walls of the channels may have structural features for special applications. The outside raised wall of the channel may be “fluted” so that a thin region along the wall facilitates heat exchange between the contents of the channel and the medium outside of the channel. In some applications, a plurality of thin regions along the wall may be desired. In these embodiments, the overall strength of the raised channel walls is not substantially affected, as regions of the wall are appreciably thicker. Other types of patterns are also possible. For alignment purposes, the top part of the raised wall preferably is relatively smooth.

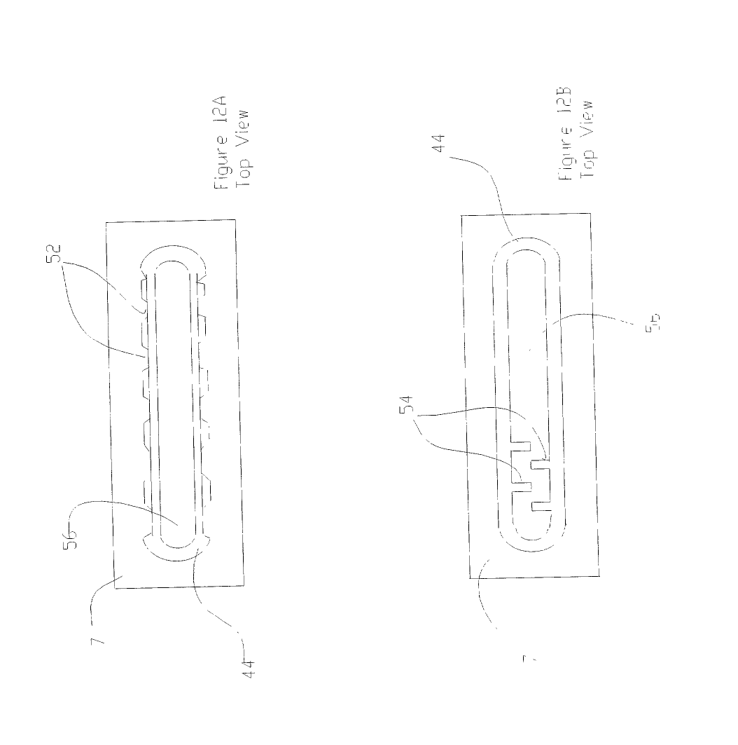

FIGS. 12A and 12B illustrate the top views of microfluidic devices with raised walls on their surfaces. The inside or outside surface of the raised channel wall may be patterned at least along some length of the wall to provide restricted flow, filtering or other performance features. Generally, a channel incorporating filter or distillation column structures will comprise a channel structure positioned within the channel and oriented perpendicular to the channel sidewall, and perpendicular to the channel bottom.

FIG. 12A shows the top view of an open channel 56 with raised channel walls 44 in which the outside surface of the raised channel wall contains a series of thin regions 52. These thin regions of the channel walls facilitate cooling, heating or fluid pumping. The top of the raised channel wall may or may not be sculptured to serve as an alignment feature. A schematic view of an open channel 56 with channel walls 44 comprising filter structures 54 are illustrated in FIG. 12B. The filter structures 54 allow the section of the channel to act as a filter or distillation plates for a column. Such structures may also be fabricated from the bottom of the channel and the surface of a second substrate that interfaces and aligns with the first substrate. A combination of different patterns on the inside and outside surfaces of the raised walls, the floor of the channel, and the cover side of the channel is possible.

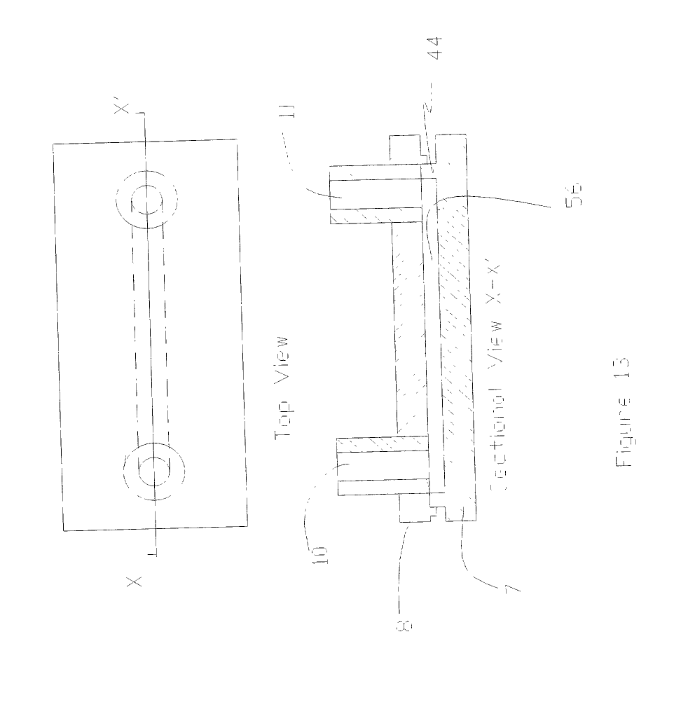

FIG. 13 provides top and sectional views of an assembled microfluidic device with a single raised channel 56 with capillaries 10 and 11 attached to channel access ports which provide access to the channel for sample and buffer input or transport to a spectrometer for analysis.

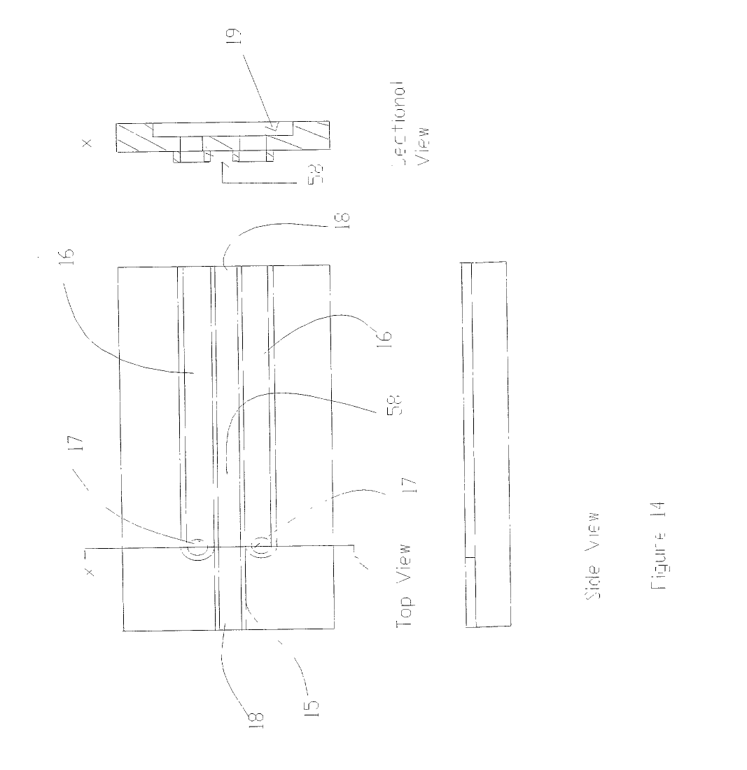

FIG. 14 shows the top view of a set of open nested channels. The central channel 58 is a channel that is open at either end that allows fluid inlet and outlet from the two sides of the substrate. The channel end openings 18 are shown at the sides of the device substrate. The adjacent channels 16 have a fluid input port 17 and a fluid outlet port that opens on to the side of the substrate 18′ in each of the channels 16. The two sidewalls of the central channel 58 are shared by channels 16 on each side. The sectional view of FIG. 14 shows a substrate cutout 19 on the opposite side of the substrate from the channel structures. The substrate cutout 19 can be mated and aligned with another substrate that will provide fluid for channels 16. These nested channels may be used for transporting liquid in the central channel 58 and a gas in the side channels 16. When a nozzle is attached to one end of the channel 58, these nested channels may be used for generating an electrospray.

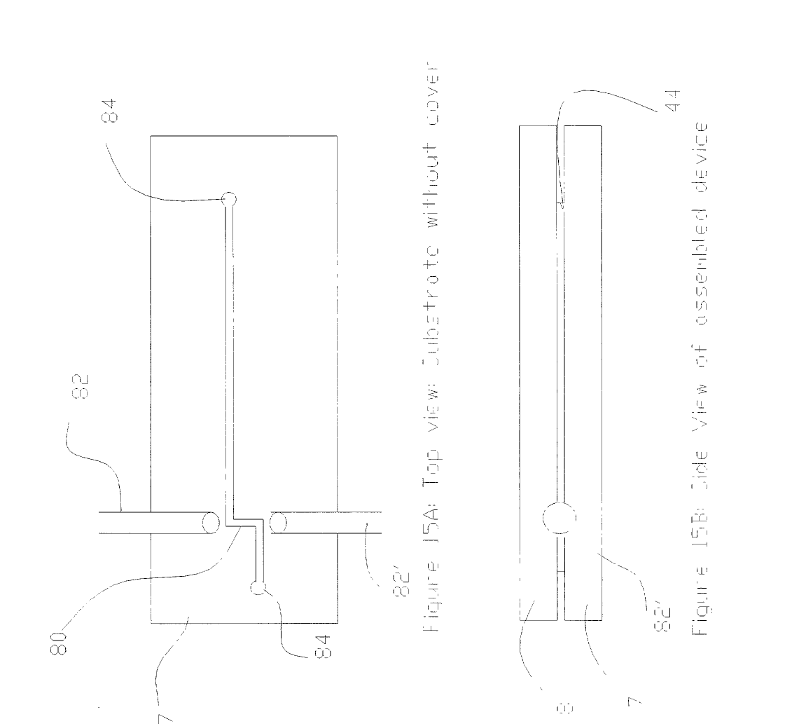

Another embodiment of the present invention provides for samples detection within the microfluidic device. FIGS. 15A and 15B provide top and side views respectively of a raised channel incorporating an architectural element to provide an extended optical path length for sample analysis. FIG. 15A shows the device without a cover piece or a secondary substrate over the primary substrate 7. A zigzag element 80 in the channel serves to increase the optical path of the sample. Optical fiber cables 82, 82′ carry the light from the light source and to the detector after it has passed through the channel in the zigzag portion 80. Fluid inlet and outlet ports 84 are also shown on this device. The side view of this microfluidic device with a cover piece 8 is shown in FIG. 15B. The zigzag element of the channel is obscured in this view by an optical fiber cable 82′ that fits in a space defined between the substrate 7 and the cover piece 8. To form the zigzag portion, the channel comprises a first and second linear sections. These linear sections are perpendicular. The channel may also extend into a third linear section, which is nonparallel to the second linear section.

### Process of Making Microfluidic Devices

The microfluidic devices of the invention are particularly suited to inexpensive fabrication methods. The devices of this invention may be manufactured by injection molding a suitable thermoplastic. Suitable thermoplastics include polycyclic olefin polyethylene copolymers, poly methyl methacrylate (PMMA), polycarbonate, polyalkanes and polystyrenes. Polycyclic olefin polyethylene co-polymers are especially suitable. Various grades of such polymers by the trade name of Topas® are examples of this type of polymers. Generally thermoplastic polymers with low melt viscosity including thermoplastics blended with liquid crystalline polymers as processing aid and other liquid crystalline polymer containing polymers such as Zenite® (DuPont Company) and the like, high chemical purity, high chemical resistivity and thermal stability are suitable, including non-commercial polymers. Materials with appropriate optical properties are preferred.

The microfluidic devices can be fabricated in accordance with the invention by compression molding and casting on a wide range of polymers. Polymers preferred for microfluidic devices are low melt viscosity polymers with minimal amount of leachable additives. Polycyclic olefin polyethylene co-polymers are preferred. PMMA, polycarbonate, polystyrenes, polyalcohols such as polybutanol and polycrylate-polyalcohol co-polymers, ionomers such as Surlyn® and bynel ®, and others are suitable Where optical transparency of the substrates is not required, polyalkanes such as polyethylene and polypropylene of different grades, thermoplastics containing liquid crystalline polymers and polymer blends exemplified by commercial products such as Zenite® and the like, fluoropolymers of different grades and different fluorine content may be used. More than one kind of polymer may be used as a substrate in the devices described herein.

A process of making microfluidic devices through injection molding includes first preparing an injection molding mold or mold insert. The injection molding mold or mold insert is typically formed as a negative impression of whatever channel architecture, or device features are desired in the microfluidic device. A polymeric material is injected into the injection molding mold or mold insert, and the polymeric material is cured to form the device component.

Because the channel architecture of the devices described herein provide for interconnecting ducts or capillaries to provide fluids to various channels in multiple layers of substrates, larger critical dimensions are feasible for operation. These larger critical dimensions facilitate alignment between multiple substrates and components, as well permit fabrication by injection molding techniques.

When preparing a microfluidic device by injection molding, a polymeric material is injected into an injection molding mold or mold insert and the polymeric material is cured in the model to form the substrate of the microfluidic device and the substrate is removed from the injection molding mold or mold insert,

An injection molding mold or mold insert may be prepared from materials such as metal, silicon, ceramic, glass, quartz, sapphire and polymeric materials, and forming the negative impression of the channel architecture may be achieved by techniques such as photolithographic etching, stereolithographic etching, chemical etching, reactive ion etching, laser machining, rapid prototyping, ink-jet printing and electroformation. With electroformation, the injection molding mold or mold insert is formed as the negative impression of the channel architecture by electroforming metal, and the metal mold is polished, preferably polished to a mirror finish.

For non-metallic molds for injection molding, the mold may be made of a flat and hard material such as Si wafers, glass wafers, quartz or sapphire. The microfluidic design features can be formed in the mold through photolithography, chemical etching, reactive ion etching or laser machining commonly used in microfabrication facilities. Some ceramics may also be used.

Molds may also be made from a “rapid prototyping” technique involving conventional ink-jet printing of the design, or direct lithography of resists such as Su-8, or direct fabrication of the mold with photopolymers using stereolithography, direct 3-dimensional fabrication using polymers and other similar and related techniques using a variety of materials with polymers. A resulting polymer-based mold may be electroformed to obtain a metallic negative replica of the polymer-based mold. Metallic molds are appropriate for injection-molding polymers that require the mold to be heated. The commonly used metal for electroforming is nickel, although other metals may also be used. The metallic electroformed mold is preferably polished to a high degree of finish, or “mirror” finish before use as the mold for injection mold. This finish is comparable to the finish obtained with mechanical polishing of submicron to micron size abrasives. Electropolishing and other forms of polishing may also be used to obtain the same degree of finish. Additionally, the metallic mold surfaces should preferably be as flat and as parallel as the Si, glass, quartz, or sapphire wafers.

For microfluidic features that are larger than 20 μm, chemical etching by photolithography techniques, electric discharge machining (EDM), conventional machining on metal using precision tools, or a combination of both technologies may also be used to fabricate the mold. For microfluidic feature fabrication using chemical etching, a suitable metal is chrome. The resulting machined mold preferably shows a high degree of surface finish, as described herein, and the flatness of the nominal surface of the mold (excluding the microfluidic design features) is at least 25 μm over the surface.

A mold created as described above may be used to injection mold polymers with sub-micron accuracy of micrometer-scale features with width to depth aspect ratio about 10:1 or higher. The width of the feature may be 20 μm or smaller. The temperatures and pressures needed to create these fine microscale structures may deviate substantially from what are typically used for general injection molding.

Generally, the injection molding molds or mold inserts reflect the negative impression of the channel architecture and features for the desired microfluidic device. The negative impression of the channel architecture and features, preferably have a width greater than 100 μm and a height between 10 μm and 50 μm.

Ink-jet technology may be applied in fabricating the microfluidic devices directly, or in fabricating the molds used making microfluidic devices by injection molding. Ink-jet printing technology provides the desired microfluidic features to be printed directly on a substrate such as glass, ceramics, silicon, polymers or any organic, inorganic or hybrid materials that form a flat surface for the printing of features. A negative of the microfluidic features may be made by conventional electroplating with copper or nickel, or any other metals over the device made via printing technology. The materials forming the microfluidic features may be organic, inorganic, or a blend of organic and inorganic materials. After electroplating, the substrate and the printed microfluidic features are separated from the metal mold. The resulting metal mold is suitable for injection molding, compression molding, room temperature embossing and hot embossing. The resulting mold may also be used for castable polymers known in the art.

If only low temperature casting is needed, then the negative of the desired microfluidic features are printed with the ink-jet printer directly on a flat substrate as described above. The resulting device can be used as a mold or master for replicating the devices made of polymers.

Polymers suitable for injection molding include Topas®, a polyethene-polycyclic olefin co-polymer sold by Ticona, polymethylmethacrylate (PMMA), polycarbonate, polystyrene, and polyacrylate polybutanol co-polymers, thermoplastic blend with liquid crystalline polymer added as processing aid, polyionomers such as Surlyn ® and Bynel®.

A master device can be used to make replicas through compression molding with the above polymers and also Teflon AF®. A master can also be used for casting polymer devices with any polymers that can be polymerized inside the mold with polymer precursors and a catalyst. Polymers suitable for casting with a master are PMMA, polymethylbutyllactone, PDMS and its derivatives, polyurethane, polyalcohols, and other castable polymers.

### EXAMPLES

### Example 1

A polymeric microfluidic device similar in form to the one shown FIG. 3 was used to separate a test sample A containing parahydroxybenzoic acid and derivatives obtained from Beckman-Coulter, Inc. for a capillary electrophoresis separation. In preparing the microfluidic device for this separation test, one end of a 1 cm long quartz capillary was inserted into a rinsing solution in a vial placed outside of the device. This capillary is referred to as an inlet capillary. The rinsing solution in this example was an 0.1 M NaOH aqueous solution in a container. The other end of the inlet capillary was inserted into the access port aligned with the channel on the device through the thickness of the substrate, but did not protrude beyond the thickness of the substrate into the channel, Another 1 cm long quartz capillary was inserted the access port at the other end of the same channel, and the same capillary, called the outlet capillary, was inserted into a waste container outside of the device. The rinsing solution was pressure injected into the microfluidic channel via the inlet capillary and then out of the channel via the outlet capillary. The conditioning of the channel was completed by repeatedly rinsing the channel with rinsing solution and distilled water as necessitated by the experiment. Prior to the separation experiment, the microfluidic channel was rinsed with a buffer solution A, also supplied by Beckman-Coulter. The buffer solution A was a borate buffer with a pH between 8 and 9. It is not necessary to perform a rinsing routine when the microfluidic channel is pre-conditioned. To start a separation, the microfluidic channel and the inlet and outlet capillaries were first filled with run buffer A. The free end of the inlet capillary was immersed in a container of test mix A, and the free end of the outlet capillary was immersed in a container filled with buffer A solution to the same level. An electrode was placed in each solution surrounding the inlet and outlet ends of the capillaries. A sample injection was accomplished either electrokinetically or with pressure. As soon as a sample plug was placed inside the inlet capillary, the inlet capillary was taken out of the test mix A container, and placed in the container with buffer A. An electrode in the buffer A container delivered the voltage needed, typically under 5 KV for a total separation channel length of 5 cm, to separate the three components in test mix A using capillary electrophoresis. A UV spectrometer was the detector for the analytes. The spectrometer comprised an optical fiber carrying UV light to a UV-transmitting part of the microfluidic channel close to the outlet capillary, and a second optical fiber on the opposite side of the channel. The second optical fiber receives the UV light passing through the microfluidic channel and relays the light to a UV detector. Three peaks were recorded as a function of UV absorption around 280 nm against time, which was less than three minutes from the start of the separation to the time when the third peak passed by the optical fiber detector. The UV spectrometer can also be placed at the outlet capillary where from 0.5 to 3 mm of polymer coating was burnt off to expose the silica capillary that transmits UV light. This latter mode of detection is especially desirable if the polymer substrate used does not transmit sufficient UV light in the wavelength range of interest.

In a corollary experiment of the same nature, the experiment was carried out in the same manner until the sample was either pressure or electrokinetically injected into the inlet capillary. Then the inlet capillary was taken out of the sample vial into the buffer vial, and the sample plug inside the inlet capillary was pushed with pressure by the buffer until it passes through a UV light path provided by a UV light-carrying optical fiber from a UV light source and a UV light carrying optical fiber to the UV detector. These optical fibers were distinct from those at the other end of the channel or the outlet capillary. These optical fibers on the inlet side were placed either at the quartz capillary end inserting into the inlet access port or the beginning of the microfluidic channel. When the UV detector detected UV absorbance as the sample plug was intercepted by the UV light path, the pressure transport of the sample plug was stopped, and a high voltage of less than 5 KV was placed on the electrode placed inside the buffer vial. The placement of an extra set of optical fibers at the inlet end minimizes the electrophoretic separation in the quartz capillary. The separation and detection of the three peaks were carried out as described above.

### Example 2

A similar device as shown in FIG. 3 was used in an HPLC separation. The microfluidic channel in the device was packed with silica beads for HPLC operation. The inlet capillary was T'd off with microtight fittings to mobile phase reservoirs and their associated pumps. UV detection was carried out in the similar fashion as in Example 1.

### Example 3

A device similar to that shown in FIG. 4 was used in a separation of test mix A as described in Example 1. The detector was placed between the inlet capillary 10 and capillary 14. After peak #2 had passed by the detector window, the voltage on the electrode in the buffer waste container, i.e., the container in which capillary 14 was immersed, was reduced to zero, and a voltage was put on the container for the solution where the free end of capillary 11 was immersed. The analyte in peak #2 was collected for further operations. In this experiment, the length of the microfluidic channel between capillary 10 and capillary 14 is longer than that between capillaries 14 and 11.

### Example 4

This HPLC experiment was carried out with a device similar in form as that in FIG. 4, except that the microfluidic channel was packed with silica column materials. The composition of the mobile phase was changed by pumping two different solvents at different rates through capillary 10 and capillary 14. Capillary 10 and capillary 14 were placed almost opposite to each other. The rest of the experiment was carried out as described above. One way to extract and collect analytes was carried out with an additional hole and capillary insert, not shown in FIG. 4.

### Example 5

A polymer microfluidic device serving the function of an electrospray-mass spectrometer interface was fabricated using the technology of this invention. The device was fabricated by injection molding 5 different substrates using a polyethylene-polycyclic olefin copolymer as the substrates. Each of the substrates is aligned accurately with its counterparts with the registration features which may be the raised channel walls, steps in the cover substrate fitting into channel and other locating mechanisms described in this application. The substrates were bonded together with an appropriate adhesive outside of the raised walls of the channel or by heating the substrates to the heat deflection temperature of the polymer and apply gentle pressure of no more than a few hundred psi, or by using a film of hexane on the outside of the channel wall as a solvent to dissolve enough polymer for bonding.

Substrate #1, which may be represented by the substrate shown in FIG. 14, had three parallel and adjacent channels. Each channel on substrate #1 was formed by raised walls. The raised walls of the channel in the middle was shared by the channel on either side of the middle channel. The raised walls were 75 μm thick each and 50 μm high. The middle channel was a hemispherical cross-section and the diameter of the channel after substrates #1 and #2 had been assembled was 90 μm. The middle channel ran the entire length of the substrate. The two adjacent channels were each about 300 μm wide. One end of each of these two channels opened at one end of the substrates, while the other end of each of these two channels ended about two-thirds of the length of the substrates.

Substrate #2 had a channel that was aligned with the middle channel in substrate #1 to 50 μm tolerance to create a channel with a symmetrical cross-sectional shape. Substrate #2 did not have alignment features for the adjacent channels to the middle channel.

On substrate #3, the raised wall of the channel was circular. This substrate was mated and aligned with one end of the middle microfluidic channel formed by substrates #1 and #2. The circular raised wall served as the nozzle for electrospray mass spectrometry and was metallized by a film of platinum deposited on the outside wall. The nozzle opening had a 20 μm internal diameter, and 100 μm outer diameter.

In each of the 300 μm wide channel on substrate #2, a port of about 300 μm in diameter was located and in fluid communication with the 300 μm wide channel. The port opened into a circular depression on substrate #2 so that the depth of the port from the depression to the fluid channel was about 500 μm. Into this circular depression was mated a circular protrusion from substrate #4 to fit to within 50 μm of the circular opening. Adhesive was used on the outside of the circular opening. On the opposite side of this circular protrusion was a hole with pipe threads or microtight threads.

A channel up to 2 mm in diameter ran from the side of the hole with the threads to the center of the circular protrusion on the other side of substrate #4. An external gas source such as dry nitrogen gas was connected to the pipe or microtight fitting to supply gases for nebulizing the liquid coming out of the nozzle end of the 90 μm microfluidic channel. A liquid used as a sheath liquid may also be supplied instead. If both are needed, an additional set of two channels placed adjacent to the 300 μm channels may be fabricated.

Likewise, the end of the 90 μm diameter channel opposite to the nozzle end was mated and aligned with raised channel walls of a channel in substrate #5 which also had a microtight fitting receptacle for accepting a capillary that would come from the sample outlet of a HPLC, a capillary electrophoresis machine or another sample injection source such as a microtiter plate.

Substrate #5 may also be a microfluidic device performing a variety of functions such as separation, dilution, concentration, etc and substrate #5 in this case may be made of two parts. Substrate #4 may be fabricated by conventional mechanical machining. After the assembly of each two substrates, a UV curable adhesive was placed between the space made by the raised channels around the outside edges of the bonded substrates and UV cured for added bonding of the substrates.

Electrospray may be achieved by subjecting the nozzle where liquid and analytes emerge to a high electric field. The microfluidic device in this example provided a low cost, disposable electrospray interface capable of nanospray. This device can be fabricated to accommodate more than one sample input in order to multiplex several separation instruments to a single mass spectrometer.

### Example 6

A polymer microfluidic device serving the function of an electrospray-mass spectrometer interface was fabricated using the technology of this invention. The device was fabricated by injection molding a polycyclic olefin copolymer as the substrate. The device included a conical microfluidic channel that connected to a conical nozzle that protrudes about 500 μm from the surface of the substrate at one end, and a cylindrical reservoir about 1 mm in diameter on the other end. The nozzle inside diameter was about 20 μm, and its outside diameter was about 50 μm. The nozzle is on one side of the substrate, and the microfluidic channel and the reservoir are through the thickness of the substrate and opens onto the opposite side of substrate from the nozzle side. The end of the nozzle was metallized by a platinum film. A sample containing acetonitrile (ACN) and parahydroxybenzoic acid (PHBA) was placed in the reservoir. A voltage of about 2 KV was placed on the platinum film, and a electrically grounded plate was placed about 5 cm from the nozzle tip. The ACN and PHBA mixture was mechanically pressed out of the reservoir through the microfluidic channel and out of the nozzle opening. A fine mist of the mixture appeared at the nozzle when the mixture underwent an electric-field induced expansion to form an electrospray suitable for mass spectrometry analysis.

In a corollary experiment, a smaller voltage was placed on the platinum film and the electrically grounded plate piece of aluminum suitable for matrix-assisted laser desorption ionization (MALDI) experiment was placed at a distance of a few mm. The PHBA/ACN mixture was sprayed onto the aluminum piece. The spot size of the sprayed material was adjusted by adjusting the applied voltage and the distance between the nozzle and the aluminum plate. A mixture of protein molecules and peptide fragments was subsequently sprayed onto the same spot containing the PHBA. In a similar manner, a mixture of PHBA/proteins in an appropriate solvent was sprayed onto the aluminum plate. The aluminum plate thus prepared is suitable for a MALDI experiment.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

### Conclusion

The present invention provides microfluidic devices that accomplish sample injection in a single channel without intersecting channels on the same plane. These devices allow electrodes, pumps and sample injection mechanisms to be placed external to the microfluidic devices. The devices also allow capillaries to be directly inserted into the microfluidic channel proper rather than a sample reservoir. Through these capillaries, sample injection from conventional microtiter plates with 96 to 1536 wells can be carried out directly into the microfluidic channel for separation without first going into a sample reservoir on the device. These capillaries may also be used as the nozzle in an electrospray interface to deliver samples from the microfluidic structures such as channels and reservoirs into a mass spectrometer for mass analysis.

The present invention also provides devices that utilize capillaries to connect individual microfluidic devices so that a plurality of channels residing in a single device or in a plurality of microfluidic devices made may be linked together to perform functions that are not possible by the individual unconnected devices themselves. Once the lab-on-a-chip function has been optimized, then the capillaries may be replaced by permanent microfluidic channels as interconnects. These interconnecting ducts may not reside on the plane as the main microfluidic features. For example, these interconnects may be on the cover plate. The interconnecting channels with external capillaries allow microfluidic devices made of different materials to be integrated into a single microfluidic system. For example, if one function of the microfluidic system needs to be able to withstand high temperature as in the case of a microreactor, this part of the microfluidic system may be made of heat-resistant materials such as ceramics or silicon, and be connected back to the rest of the system which may be made of glass, polymer or any other suitable materials.

The present invention also provides devices with channel width larger than those typically used in the art, e.g. 100 μm. Channels larger than 100 μm allow accurate alignment of microfluidic features on surfaces of different substrates using simple location devices. For example, the microfluidic features can be fabricated in one surface of a substrate, and on the surfaces of the cover plate as well, and they can be aligned to within 25 μm with conventional mechanical machining techniques. In this manner, substrates and covers may be stacked in multiple layers with all the microfluidic features accurately aligned from layer to layer. A channel width larger than 100 μm allows break-through low-cost, fast turn around fabrication methods such as ink-jet lithography. A channel width larger than 100 μm allows ultraviolet and mass spectrometry detection to have higher sensitivity because larger volumes of analyte can be accommodated within the channel.

The present invention also provides devices that may be used for multidimensional separations.

What is claimed is:

1. An microfluidic device comprising:
A) a substrate with a top surface comprising a channel, wherein the channel has a width, a bottom and a sidewall; and
B) a cover positioned over the substrate in alignment with the substrate,
wherein the channel is accessed through an access port to the channel, the access port positioned on at least one of the cover and the bottom.

2. The microfluidic device of claim 1 wherein the access port to the channel is an opening on the channel bottom.

3. The microfluidic device of claim 1 wherein the access port to the channel is an opening on the cover.

4. The microfluidic device of claim 1 wherein the channel bottom is coplanar with the top surface of the substrate, and the channel sidewall rises from the substrate surface at an angle between about 45 and 135 degrees, wherein the substrate, and the sidewall are composed of a polymeric material.

5. The microfluidic device of claim 4 wherein the channel sidewall comprises a thin region of the sidewall.

6. The microfluidic device of claim 5 wherein the sidewall comprises a plurality of thinned regions.

7. The microfluidic device of claim 5 wherein a metal is deposited on the thinned region.

8. The microfluidic device of claim 1 wherein the channel bottom is beneath a plane co-planar with the top surface of the substrate.

9. The microfluidic device of claim 1 wherein the device further comprising an alignment device adapted to align the cover with the substrate.

10. The microfluidic device of claim 9 wherein the alignment device is a dowel pin positioned on the substrate.

11. The microfluidic device of claim 9 wherein the alignment device is a protrusion positioned on the cover.

12. The microfluidic device of claim 9 wherein the alignment device is accurate to better than 0.001 inch.

13. The microfluidic device of claim 1, the device further comprising a capillary positioned in the channel access port and inserted in the channel, wherein the access port has a diameter and the capillary has an outer diameter, and wherein the capillary outer diameter and the access port diameter are approximately equal.

14. The microfluidic device of claim 13 wherein an adhesive secures the outer circumference of the capillary to the access port.

15. The microfluidic device of claim 13 wherein the capillary is made of a second polymeric material that is transparent.

16. The microfluidic device of claim 1, the device further comprising a capillary positioned in the channel access port and inserted in the channel, wherein the capillary has an inner cross-sectional area and the channel has a cross-sectional area and the capillary cross-sectional area and the channel cross-sectional area are approximately equal.

17. The microfluidic device of claim 1 wherein the device comprises a first and a second channel, the second channel positioned below the first channel, the first channel has a conduit extending from the bottom of the first channel to the second channel.

18. The microfluidic device of claim 1 wherein the device further comprises a structure selected from the group consisting of a reservoir structure, a detector window region, a microreactor and a distillation column, wherein a capillary connects the channel to the structure.

19. The microfluidic device of claim 1 wherein the substrate comprises a plurality of conical nozzles, the conical nozzles positioned in a geometrical array.

20. The microfluidic device of claim 1 wherein the cover further comprises an interconnecting duct, the duct connects to at least one channel via the access port.

21. The microfluidic device of claim 1 wherein the sidewall comprises an inner surface facing the channel and an outer surface opposite the inner surface; and wherein the cover comprises a bottom surface, the bottom surface facing the top surface of the substrate; the cover further comprising a protrusion that extends from the bottom surface of the cover; wherein the cover protrusion is adjacent to the inner surface of the sidewall.

22. The microfluidic device of claim 1 wherein the sidewall comprises an inner surface facing the channel and an outer surface opposite the inner surface; and wherein the cover comprises a bottom surface, the bottom surface facing the top surface of the substrate; the cover further comprising a protrusion that extends from the bottom surface of the cover; wherein the cover protrusion is adjacent to the outer surface of the sidewall.

23. The microfluidic device of claim 22 wherein an interstitial region is formed between the top surface of the substrate and the bottom surface of the cover in regions bordering the outer surface of the sidewall.

24. The microfluidic device of claim 1 wherein the channel comprises a channel structure positioned within the channel and oriented perpendicular to the channel sidewall, and perpendicular to the channel bottom.

25. The microfluidic device of claim 1 wherein the channel comprises a first linear section and a second linear section, wherein the first and second linear sections are perpendicular.

26. The microfluidic device of claim 1 wherein the channel bottom has a width of greater than 100 μm.

27. The microfluidic device of claim 1 wherein the channel sidewall is between 10 μm and 50 μm in height.

28. The microfluidic device of claim 1 wherein the sidewall and channel bottom are formed from the polymeric material.

29. The microfluidic device of claim 1 wherein the polymeric material is a low melt viscosity polymer.

30. The microfluidic device of claim 29 wherein the polymeric material is selected from the group consisting of polycyclic olefin polyalkane co-polymers, poly methyl methacrylate, polycarbonate, polyalkanes, polystyrenes and polymer blends containing a liquid crystalline polymer as an additive.

31. The microfluidic device of claim 1 wherein the device comprises an additional substrate, the additional substrate comprising a channel architecture, wherein the substrates are bonded together, and further wherein the device comprises a conduit connecting the channel and the channel architecture.

32. A process of making a microfluidic device, the device comprising a substrate and a channel architecture, the method comprising:
A. preparing an injection molding mold, wherein preparing the injection molding mold comprises forming a negative impression of the channel architecture;
B. injecting a polymeric material into the injection molding mold or mold insert, and
C curing the polymeric material.

33. The process of claim 32 wherein the injection molding mold is prepared from a material selected from the group consisting of metal, silicon, ceramic, glass, quartz, sapphire and polymeric material.

34. The process of claim 32 wherein preparing the injection molding mold comprises forming the negative impression of the channel architecture by a technique selected from the group consisting of photolithographic etching, stereolithographic etching, chemical etching, reactive ion etching, laser machining, rapid prototyping, ink-jet printing and electroformation;

35. The process of claim 32 wherein preparing the injection molding mold comprises forming the negative impression of the channel architecture by electroforming metal, and wherein the process further comprises polishing said mold.

36. A microfluidic device comprising a substrate with a top surface comprising a channel, wherein the channel comprises a bottom and a sidewall, said substrate formed by a process comprising:
preparing an injection molding mold, wherein preparing the injection molding mold comprises forming a negative impression of the channel;
injecting a polymeric material into the injection-molding mold;
curing the polymeric material to form the substrate; and
removing the substrate from the injection-molding mold.

37. A microfluidic device comprising:
A) a substrate with a top surface comprising a plurality of non-intersecting channels, wherein each channel has a width, a bottom, and a sidewall; and
B) a cover positioned over the substrate in alignment with the substrate, wherein each of the channels are accessed through an access port to the channel, the access port positioned on at least one of the cover and the bottom.
